(19) United States
(12) Patent Application Publication
(10) Pub. No.: US 2017/0091715 A1
(43) Pub. Date: Mar. 30, 2017

(54) EVENT CONFLICT DETECTION IN A COMMUNICATION

(71) Applicant: International Business Machines Corporation, Armonk, NY (US)

(72) Inventors: Alaa Abou Mahmoud, Dracut, MA (US); Vinod A. Valecha, Maharashtra (IN)

(21) Appl. No.: 14/869,574

(22) Filed: Sep. 29, 2015

(51) Int. Cl. G06Q 10/10

(52) U.S. Cl. CPC G06Q 10/1095

(57) ABSTRACT

A method for detecting a conflict may include detecting a reference to a date and time in a communication. The method may also include determining a participation of the user in a prospective event associated with the date and time based on the context of the communication. The method may additionally include comparing the date and time associated with the prospective event to a date and time of previously scheduled events in a calendar system to detect any conflict. The method may also include detecting a conflict between the prospective event and a previously scheduled event in response to the date and time associated with the prospective event at least partially corresponding to the date and time of the previously scheduled event. The method may further include automatically presenting an indication of the conflict in response to detecting the conflict.

### BACKGROUND

Aspects of the present invention relate to electronic communications, such as mail clients and online networks, and more particularly to a method, system and computer program product for detecting an event conflict in a communication.

Electronic communications, such as Instant Messaging (IM) chat, text message, email and similar electronic communications are commonly used for efficient communications. However, a user may commit to a particular date or a particular date and time referenced in a communication without knowing or recalling that the user has a conflict with that particular date or that particular date and time that the user may have previously scheduled in a calendar system. The user would have to manually switch or take extra effort and time to access the calendar system or time management program to determine the existence of the conflict resulting in inefficiency.

### SUMMARY

According to one embodiment of the present invention, a computer implemented method for detecting a conflict with an event in a communication may include detecting, by a processor, a reference to a date or a date and time in a communication associated with a user and determining, by the processor, a context in which the date or date and time is used in the communication in response to detecting the reference to the date or the date and time in the communication The method may also include determining, by the processor, a participation of the user in a prospective event associated with the date or the date and time based on the context of the communication. The method may additionally include comparing, by the processor, the date or the date and time associated with the prospective event to a date or a date and time of each of a plurality of scheduled events previously scheduled in a calendar system of the user to detect any conflict in response to the participation of the user in the prospective event. The method may also include detecting, by the processor, a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event. The method may further include automatically presenting, by the processor, an indication of the conflict to the user in response to detecting the conflict.

According to another embodiment of the present invention, a system for detecting a conflict with an event in a communication may include a processor and a module operating on the processor for detecting a conflict with an event in a communication. The module may be configured to perform a set of functions that may include detecting a reference to a date or a date and time in a communication associated with a user and determining a context in which the date or date and time is used in the communication in response to detecting the reference to the date or the date and time in the communication. The set of functions may also include determining a participation of the user in a prospective event associated with the date or the date and time based on the context of the communication. The set of functions may also include comparing the date or the date and time associated with the prospective event to a date or a date and time of each of a plurality of scheduled events previously scheduled in a calendar system of the user to detect any conflict in response to the participation of the user in the prospective event. The set of functions may also include detecting a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event. The set of functions may further include automatically presenting an indication of the conflict to the user in response to detecting the conflict.

According to another embodiment of the present invention, a computer program product for detecting a conflict with an event in a communication may include a computer readable storage medium having program instructions embodied therewith, wherein the computer readable storage medium is not a transitory medium per se, the program instructions being executable by a device to cause the device to perform a method that may include detecting a reference to a date or a date and time in a communication associated with a user and determining a context in which the date or date and time is used in the communication in response to detecting the reference to the date or the date and time in the communication. The method may also include determining a participation of the user in a prospective event associated with the date or the date and time based on the context of the communication. The method may also include comparing the date or the date and time associated with the prospective event to a date or a date and time of each of a plurality of scheduled events previously scheduled in a calendar system of the user to detect any conflict in response to the participation of the user in the prospective event. The method may additionally include detecting a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event. The method may further include automatically presenting an indication of the conflict to the user in response to detecting the conflict.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A-1B are a flow chart of an example of a method for detecting a conflict with an event in a communication in accordance with an embodiment of the present invention.

FIG. 2A is an example of a graphical user interface (GUI) including an electronic conversation and illustrating an example of an indication of a conflict in accordance with an embodiment of the present invention.

FIG. 2B is the exemplary GUI of FIG. 2A illustrating an example of presenting alternative available dates and times for association with a prospective event in accordance with an embodiment of the present invention.

FIG. 3 is a block schematic diagram of an example of a system for detecting a conflict with an event in a communication in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

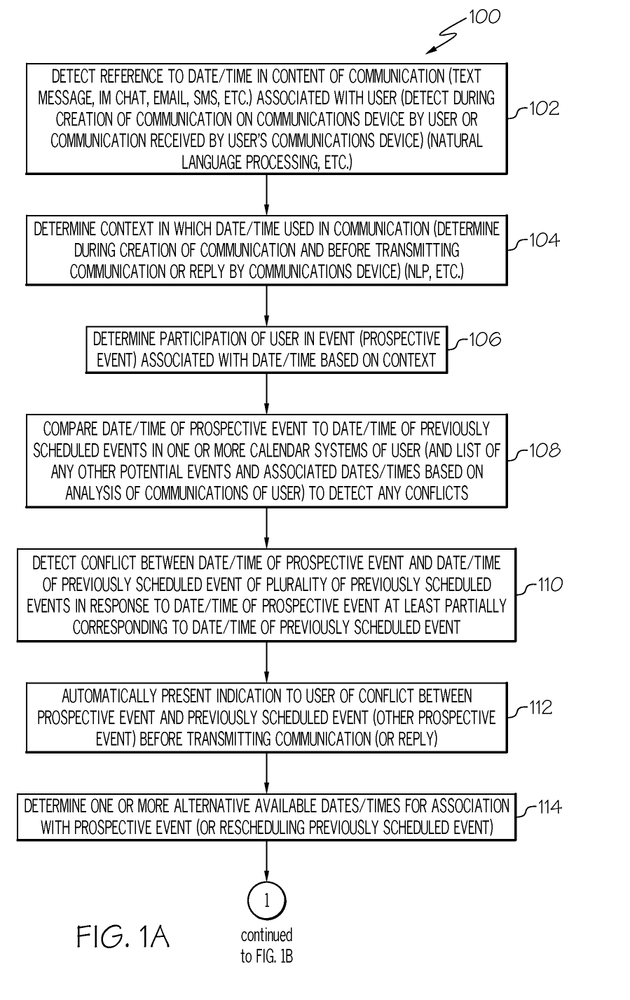

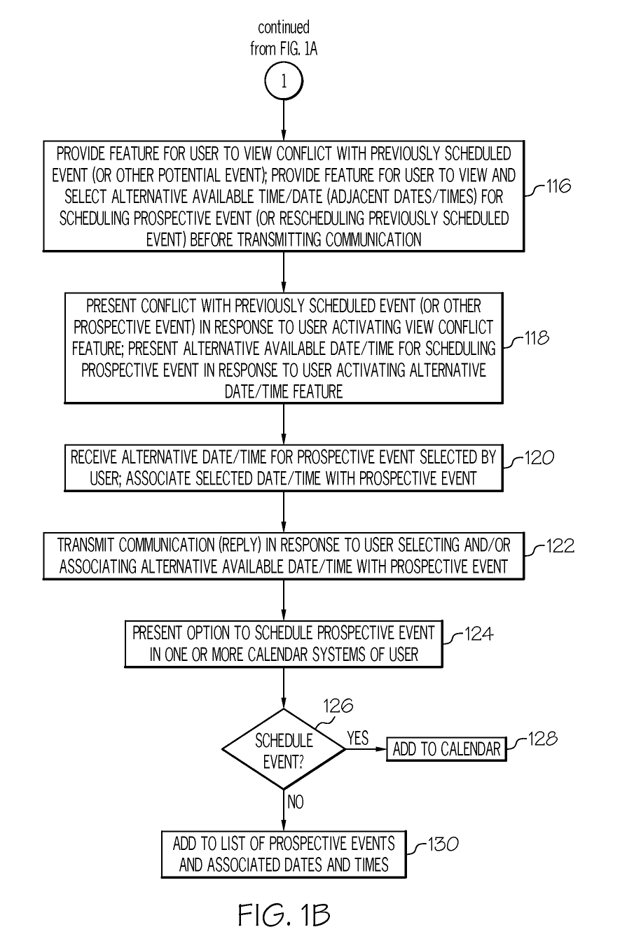

FIGS. 1A-1B are a flow chart of an example of a method 100 for detecting a conflict with an event in a communication in accordance with an embodiment of the present invention. In block 102, a reference to a date or a date and time in a communication associated with a user may be detected. Examples of the communication may include any type of electronic communications or messaging, such as a text messaging, IM chat, e-mail, short message service (SMS) or similar electronic communications over a network such as the Internet, or a private or proprietary network. The communication associated with the user may be a communication or message being created by the user on a communications device of the user or a communication that is received by the communications device of the user that is sent by another user. The reference to the date or the date and time in the communication may be detected or determined using natural language processing (NLP) or other software or program for determining content of a communication or message.

In block 104, a context in which the date or the date and time is used in the communication may be determined in response to detecting the reference to the date or the date and time in the communication. The context in which the date and/or time is used in the communication may be determined during creation of the communication and before transmitting the communication or replying to a message form another user by the communications device of the user. The context in which the date and/or time is used in the communication may be determined using NLP or other software for determining content.

In block 106, participation of the user in an event or prospective event associated with the date or the date and time may be determined based on the context of the communication. The event associated with the date or the date and time referenced in the communication may be considered to be a prospective event because the date or date and time associated with the referenced event have not been entered or scheduled in a calendar system of the user. The calendar system may include but is not necessarily limited to any type of electronic calendar system or electronic time management mechanism or system.

In block 108, the date or the date and time associated with the prospective event may be compared to a date or a date and time of each of a plurality of scheduled events previously scheduled in the calendar system of the user to detect any conflict in response to the participation of the user in the prospective event. In another embodiment, a list of potential events and associated dates or dates and times based on analysis of communications of the user may be maintained. The potential events may be prospective events associated with dates and/or times that may have been referenced in previous or earlier communications of the user but were not scheduled or entered in the calendar system of the user. The date or the date and time associated with the current prospective event may also be compared to the list of potential events and associated dates or dates and times to determine any potential conflicts with any of the potential events in the list of potential events should any conflicting potential event be subsequently entered or scheduled in the calendar system of the user.

In block 110, a conflict between the date or the date and time associated with the prospective event and the date or the date and time of a previously scheduled event of the plurality of previously scheduled events in the user's calendar system may be detected or determined in response to the date or the date and time associated with the prospective event at least partially corresponding to the date or the date and time of the previously scheduled event or potential event, if a list of potential events is maintained, based on comparison of the dates or dates and times.

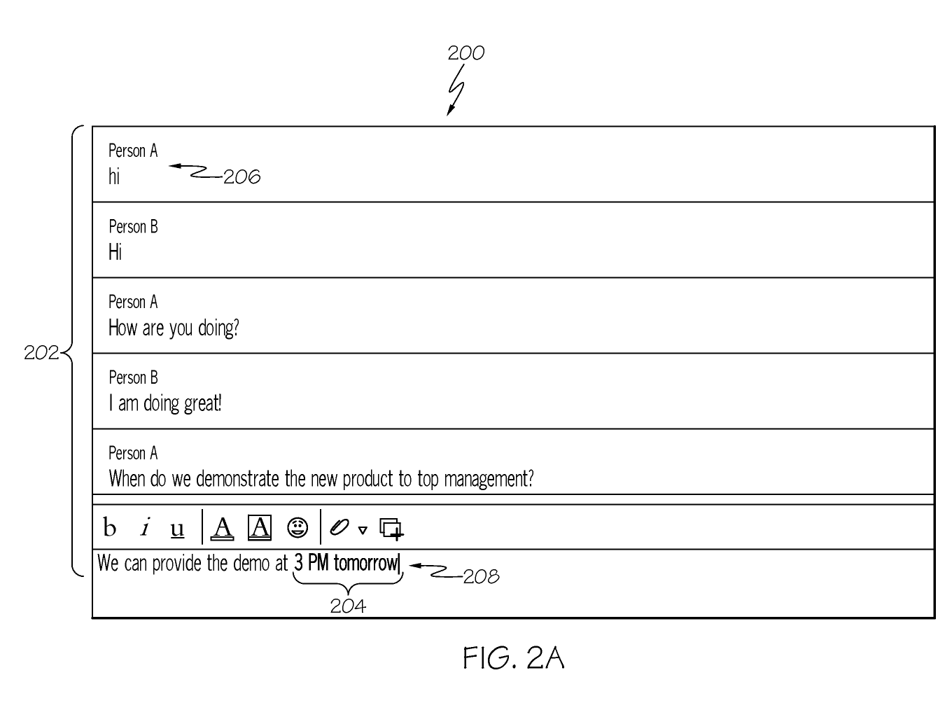

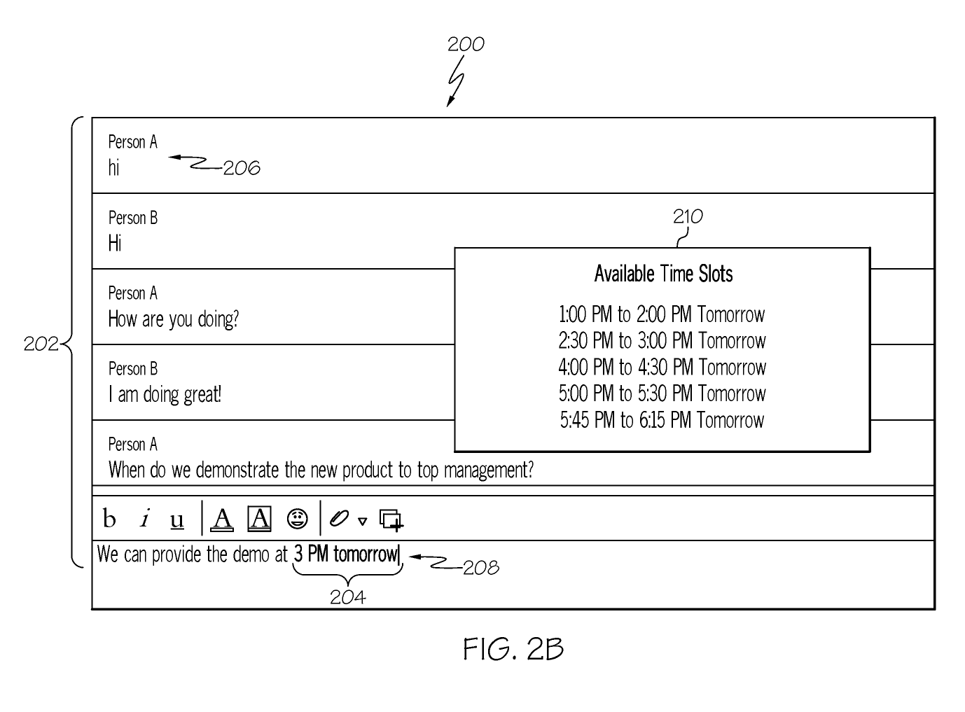

In block 112, an indication may be automatically presented to the user of the conflict between the prospective event and the previously scheduled event or potential event before transmitting the communication or transmitting a reply to a communication of another user. Referring also to FIG. 2A, FIG. 2A is an example of a graphical user interface (GUI) 200 including an electronic conversation 202 and illustrating an example of an indication of a conflict 204 in accordance with an embodiment of the present invention. The electronic conversation 202 may include a plurality of communications 206 or messages between users, such as Person A and Person B as illustrated in the exemplary GUI 200 in FIG. 2A. The electronic conversation 202 and communications 206 may be any type of electronic conversation and communications similar to that previously described, such as for example, text messaging, IM chat, e-mail, short message service (SMS) or similar electronic communications. The indication of the conflict 204 may be distinguished from other text or content in a particular communication 208 or message within the conversation 202 to bring immediate attention of the user creating the particular communication 208 or message. For example, the indication of the conflict 204 may be in a different color, such as red for example, to distinguish from the other text or content. The indication of the conflict 204 may be highlighted and/or configured to flash to draw the user's attention.

In a block 114, one or more alternative available dates or dates and times for association with the prospective event may be determined. Alternatively, one or more alternative available dates or dates and times for rescheduling the previously scheduled event that conflicts with the prospective event may be determined. For example, the user may be presented an option for selecting an alternative available date or date and time for the prospective event or for rescheduling the previously scheduled event with which the prospective event conflicts or corresponds.

In block 116, a feature may be provided for the user to at least one of view the conflict and alternative available dates for associating or scheduling the prospective event or rescheduling the previously scheduled event. Accordingly, the conflict with the previously scheduled event and/or potential event, if a list of potential events is maintained as described herein, may be presented to the user and an alternative available date or date and time for scheduling the prospective event or rescheduling the previously scheduled event may be presented on a display of the user's communications device for selection by the user. The same feature or a separate feature may be provided for the user to view and select an alternative available date or date and time for associating with the prospective event or scheduling the prospective event, or rescheduling the previously scheduled event. The alternative available date or date and time may be selected before transmitting the communication or transmitting a reply to a communication of another user.

In block 118, a feature may be provided for the user to view at least one of the conflict with the previously scheduled event and/or to view one or more alternative available dates or alternative available dates and times. The conflict with the previously scheduled event or other potential event from the list of potential events may be presented to the user on a display of the communications device in response to the user activating a feature, such as a view conflict feature. Alternative available dates or dates and times may be presented for association with the prospective event or for scheduling the prospective event in response to the user activating a feature, such as an alternative date/time feature. Optionally, the user may be presented a mechanism to select to present or view an alternative available date or date and time for rescheduling the previously scheduled event. The conflict feature and alternative date/time feature may be combined in a single feature or may be separate features presented on the display. For example, the conflict feature may be activated by the user performing a predetermined function to present the conflicting previously scheduled event and also alternative dates and times for association with or scheduling the prospective event may be presented, or optionally, dates and/or times for rescheduling the previously scheduled event.

The feature may be activated to present the conflict and/or alternative date or dates and times on the display of the user's communications device. For example, the feature may be activated by performing a predetermined action relative to the indication of the conflict. One or more alternative available dates or alternative available dates and times for association with the prospective event or for scheduling the prospective event or, optionally, rescheduling the previously scheduled event or potential event that are selectable by the user may be presented on a display of the user's communication device in response to activating the feature. The prospective event or rescheduling the previously scheduled event may be scheduled in response to selecting a date or selecting a date and time from the one or more alternative available dates or alternative available dates and times by the user.

An example of a feature for the user to view the conflict with the previously scheduled event or potential event may include configuring the indication of the conflict 202 (FIG. 2A) to include a link to the previously scheduled event in the user's calendar system or for the indication of the conflict to include a mechanism to retrieve the previously scheduled event or potential event and to present a representation of the previously scheduled event or potential event to the user on the display of the user's communications device. For example, the user could activate the feature by clicking-on or right-clicking the indication of the conflict 202 using a computer pointing device to present the alternative available dates or dates and times. Referring also to FIG. 2B, FIG. 2B is the exemplary GUI 200 of FIG. 2A illustrating an example of presenting alternative available dates and times 210 for association with a prospective event in accordance with an embodiment of the present invention. Optionally as previously described, the alternative dates and times may be for rescheduling the previously scheduled event. One or more available dates or available dates and times for association with the prospective event may be determined by searching the calendar system of the user for open dates and/or dates and times. For example, the available dates and/or dates and times may be adjacent to the date and/or date and time of the conflicting previously scheduled event. The available dates and times may span times or days immediate before and immediately after the conflicting scheduled event that are open or do not have anything scheduled. The list of available dates and/or available dates and times may include a mechanism or feature for the user to select one of the dates and/or dates and times from the list.

In block 120, the alternative available date or date and time selected by the user may be received by the user's communications device. The selected alternative available date or date and time may be associated with the prospective event.

In block 124, an option may be presented to the user to schedule the prospective event in one or more calendar systems of the user for the date or date and time associated with the prospective event in block 120.

In block 126, a determination may be made whether the user selected the option to schedule the prospective event at the associated date or date and time. If the user selected the option to schedule the prospective event, the method 100 may advance to block 128. In block 128, the prospective event may be added to the calendar system or systems of the user for the date or date and time selected by the user.

If the user did not select the option to schedule the prospective event in block 126, the method 100 may advance to block 130. In block 130, the prospective event may be added to the list of prospective of events along with the associated date or date and time selected by the user.

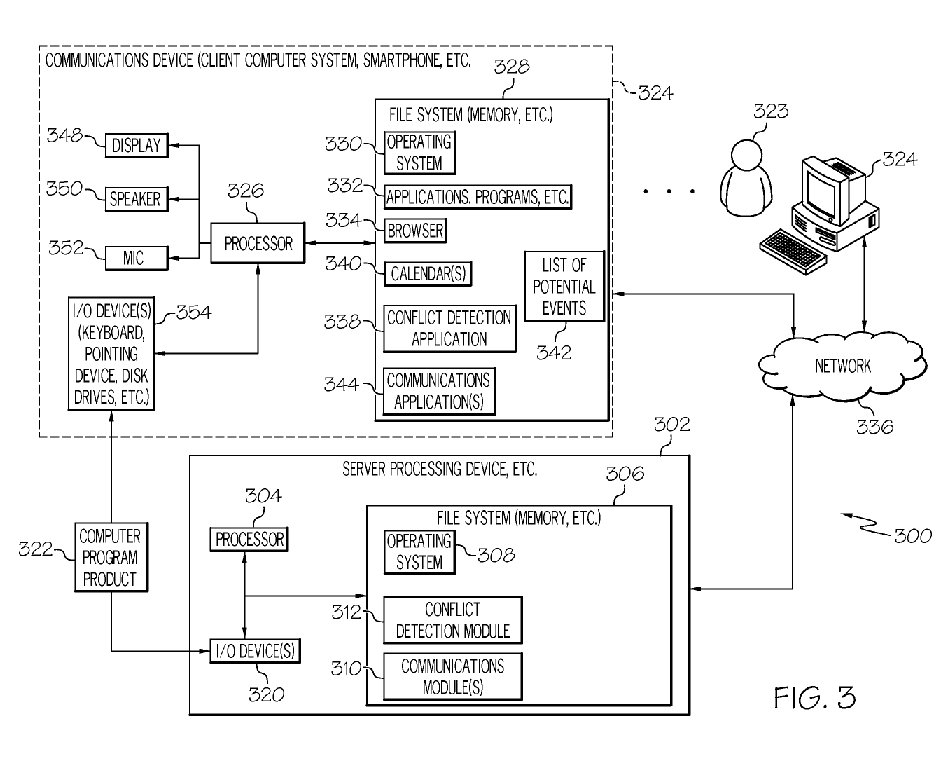

FIG. 3 is a block schematic diagram of an example of a system 300 for detecting a conflict with an event in a communication in accordance with an embodiment of the present invention. The method 100 of FIGS. 1A-1B may be embodied in and performed by the system 300 and the exemplary GUI 200 in FIGS. 2A-2B may be generated and presented by the system 300. The system 300 may include a processing device 302. The processing device 302 may be a server or similar processing device. The processing device 302 may include a processor 304 for controlling operation of the processing device 302 and for performing functions, such as those described herein with respect to method 100 in FIGS. 1A-1B. The processing device 302 may also include a file system 306 or memory. An operating system 308, applications and other programs may be stored on the file system 306 for running or operating on the processor 304. One or more communications modules 310 or systems may also be stored on the file system 306 and may be compiled and run on the processor 304 to perform the functions or operations described herein. The communications module 310 may be any type of online communications mechanism, networking arrangement or system for online or Internet communications or conversations, such as e-mail, IM chat, SMS, text messaging or similar communications system or network.

A conflict detection module 312 may also be stored on the file system 306. The method 100 of FIGS. 1A-1B may be embodied in the conflicts detection module 312 and performed by the processor 304 when the conflict detection module 312 is compiled and run on the processor 304. The conflict detection module 312 may operate in conjunction with the communications module 310. The conflict detection module 312 may be a separate component from the communications module 310 or in another embodiment, the conflict detection module 312 may be a component of the communications module 310.

The processing device 302 may also include one or more input devices, output devices or combination input/output devices, collectively I/O devices 320. The I/O devices 320 may include, but are not necessarily limited to, a keyboard or keypad, pointing device, such as a mouse, disk drive and any other devices to permit a user to interface with and control operation of the processing device 302 and to access the communication module 310 or system and conflict detection module 312. At least one of the I/O devices 320 may be a device to read a computer program product, such as computer program product 322. The computer program product 322 may be similar to that described in more detail herein. The communications module 310 and conflict detection module 312 may be loaded on the file system 306 from a computer program product, such as computer program product 322.

A member of a network, such as a social network, or user 323 of the system 300 may use a computer system 324 or communications device to access the processing device 302 or server and communications module 310 and conflict detection module 312. The computer system 324 or communications device may be any sort of communications device including a mobile or handheld computer or communications device. The computer system 324 may include a processor 326 to control operation of the computer system 324 and a file system 328, memory or similar data storage device. An operating system 330, applications 332 and other programs may be stored on the file system 328 for running or operating on the processor 326. A web or Internet browser 334 may also be stored on the file system 328 for accessing the processing device 302 or server via a network 336. The network 336 may be the Internet, an intranet or other private or proprietary network.

A conflict detection application 338 may also be stored on the file system 328. The method 100 in FIGS. 1A-1B or at least portions of the method 100 may be embodied in and performed by the conflict detection application 338. The conflict detection application 338 may be compiled and run on the processor 326 to perform functions similar to those described with respect to method 100.

The file system 328 may also include one or more calendar systems 340 or time management systems for scheduling events similar to that previously described.

The file system 328 may also include a list of potential events 342 similar to that previously described. As previously described, the list of potential events 342 may include prospective events previously referenced in communications of the user that have not been actually scheduled in at least one of the calendar systems 340 of the user but may be scheduled at a future time or may be an event the user overlooked entering or scheduling in the calendar system 340 or systems.

One or more communications applications 344 may also be stored on the file system 328. The one or more communications applications 344 may be any type of online communications mechanism for online communications or conversations. The conflict detection application 338 may be a separate component from the communications application 344 as shown in the exemplary embodiment in FIG. 3 or in another embodiment, the conflict detection application 338 may be a component of the communications application 344. The conflict detection application 338 may also be a separate component that is configured for operation in association with different types of communications applications 344 or technology, such as text messaging, IM chat, email, SMS or other electronic communications.

The communications application 344 and the conflict detection application 338 operating on the computer system 324 may interface with or operate in conjunction with the communications module 310 and conflict detection module 312 on the processing device 302 or server to perform the functions and operations described herein. Accordingly, communications application 344 and conflict detection application 338 operating on the computer system 324 may perform some of the functions and operations of the method 100 and communications module 310 and conflict detection module 312 operating on the processing device 302 or server may perform other functions of the method 100. Some embodiments of the present invention may include only the communications module 310 and conflict detection module 312 on the processing device 302 or server, and other embodiments may include only the communications application 344 and conflict detection application 338 operating on the client computer system 324 or communications device.

The client computer system 324 or communications device may also include a display 348, a speaker system 350, and a microphone 352 for voice communications. Commands may be presented on the display 348 for controlling operation of the communications module 310 and conflict detection module 312 and/or conflict detection application 338 and communications application 344 and for performing the operations and functions described herein. The exemplary GUIs 200 in FIGS. 2A-2B may be presented on the display 348.

The computer system 324 may also include one or more input devices, output devices or combination input/output devices, collectively I/O devices 354. The I/O devices 354 may include a keyboard or keypad, pointing device, such as a mouse, disk drives and any other devices to permit a user, such as user 323, to interface with and control operation of the computer system 324 and to access the communications application 340 and communications module or system 310 on server 302. The I/O devices 354 may also include at least one device configured to read computer code from a computer program product, such as computer program product 322.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A computer implemented method for detecting a conflict with an event in a communication, comprising:
detecting, by a processor, a reference to a date or a date and time in a communication associated with a user;
determining, by the processor, a context in which the date or date and time is used in the communication in response to detecting the reference to the date or the date and time in the communication;
determining, by the processor, a participation of the user in a prospective event associated with the date or the date and time based on the context of the communication;
comparing, by the processor, the date or the date and time associated with the prospective event to a date or a date and time of each of a plurality of scheduled events previously scheduled in a calendar system of the user to detect any conflict in response to the participation of the user in the prospective event;
detecting, by the processor, a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event; and
automatically presenting, by the processor, an indication of the conflict to the user in response to detecting the conflict.

2. The method of claim 1, further comprising providing a feature for the user to view an available date or an available date and time for scheduling the prospective event.

3. The method of claim 1, further comprising providing a feature for the user to view at least one of the conflict with the previously scheduled event and to view an available date or an available date and time for scheduling the prospective event or rescheduling the previously scheduled event.

4. The method of claim 3, wherein providing the feature to at least one of view the previously scheduled event and to view an available date or an available date and time for scheduling the prospective event or rescheduling the previously scheduled event comprises:
activating the feature, wherein activating the feature comprises performing a predetermined action relative to the indication of the conflict;
presenting one or more alternative dates or alternative dates and times for scheduling the prospective event or rescheduling the previously scheduled event that are selectable by the user in response to activating the feature; and
scheduling the prospective event or rescheduling the previously scheduled event in response to selecting a date or selecting a date and time from the one or more alternative dates or alternative dates and times by the user for one of scheduling the prospective event or rescheduling the previously scheduled event.

5. The method of claim 1, further comprising:
determining one or more available dates or available dates and times for association with the prospective event;
providing a feature to select an available date or an available date and time from the one or more available dates or available dates and times for association with the prospective event.

6. The method of claim 5, further comprising:
receiving the available date or the available date and time selected by the user for association with the prospective event;
associating the selected available date or available date and time with the prospective event; and
transmitting the communication or a reply to the communication associated with the user in response to associating the available date or the available date and time with the prospective event.

7. The method of claim 6, further comprising:
presenting an option to schedule the prospective event and the associated available date or the available date and time in the calendar system of the user;
adding the prospective event and the associated available date or the available date and time in the calendar system of the user in response to the user selecting the option to schedule the prospective event; and
adding the prospective event and the associated available date or the available date and time to a list of potential events and associated dates or associated dates and times.

8. The method of claim 1, wherein automatically presenting the indication of the conflict to the user comprises automatically presenting the indication of the conflict to the user during creation of the communication on a communications device of the user and before transmitting the communication.

9. The method of claim 1, wherein detecting the reference to the date or the date and time in the communication associated with the user comprises detecting the reference to the date or the date and time during creation of the communication on a communications device of the user.

10. The method of claim 1, wherein detecting the reference to the date or the date and time in the communication associated with the user comprises detecting the reference to the date or the date and time in a communication received by a communication device of the user.

11. The method of claim 1, further comprising maintaining a list of potential events and associated dates or associated dates and times from previous communications of the user.

12. The method of claim 11, further comprising comparing the date or the date and time of the prospective event to the list of potential events and associated dates or associated dates and times to detect any conflicts, and wherein detecting the conflict comprises detecting the conflict between the date or the date and time of the prospective event and the date or the date and time of the previously scheduled event, and/or the date or the date and time associated with one of the list of potential events.

13. The method of claim 1, wherein the communication is one of a text communication, an instant messaging chat, social network communication, email, and short message service and presenting the indication of the conflict comprises changing a color of the reference to the date or date and time in the communication.

14. A system for detecting a conflict with an event in a communication, comprising:
a processor;
a module operating on the processor for detecting a conflict with an event in a communication, the module being configured to perform a set of functions comprising:
detecting a reference to a date or a date and time in a communication associated with a user;
determining a context in which the date or date and time is used in the communication in response to detecting the reference to the date or the date and time in the communication;
determining a participation of the user in a prospective event associated with the date or the date and time based on the context of the communication;
comparing the date or the date and time associated with the prospective event to a date or a date and time of each of a plurality of scheduled events previously scheduled in a calendar system of the user to detect any conflict in response to the participation of the user in the prospective event;
detecting a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event; and
automatically presenting an indication of the conflict to the user in response to detecting the conflict.

15. The system of claim 14, wherein the set of functions further comprises providing a feature for the user to at least one of view the conflict with the previously scheduled event and to view an available date or an available date and time for scheduling the prospective event or rescheduling the previously scheduled event.

16. The system of claim 15, wherein providing the feature to at least one of view the previously scheduled event and to view an available date or an available date and time for scheduling the prospective event or rescheduling the previously scheduled event comprises:
activating the feature, wherein activating the feature comprises performing a predetermined action relative to the indication of the conflict;
presenting one or more alternative dates or alternative dates and times for scheduling the prospective event or rescheduling the previously scheduled event that are selectable by the user in response to activating the feature; and
scheduling the prospective event or rescheduling the previously scheduled event in response to selecting a date or selecting a date and time from the one or more alternative dates or alternative dates and times by the user for one of scheduling the prospective event or rescheduling the previously scheduled event.

17. The system of claim 16, wherein the set of functions further comprises:
receiving the available date or the available date and time selected by the user for association with the prospective event;
associating the selected available date or available date and time with the prospective event; and
transmitting the communication or a reply to the communication associated with the user in response to associating the available date or the available date and time with the prospective event.

18. The system of claim 17, wherein the set of functions further comprises:
presenting an option to schedule the prospective event and the associated available date or the available date and time in the calendar system of the user;
adding the prospective event and the associated available date or the available date and time in the calendar system of the user in response to the user selecting the option to schedule the prospective event; and
adding the prospective event and the associated available date or the available date and time to a list of potential events and associated dates or associated dates and times.

19. A computer program product for detecting a conflict with an event in a communication, the computer program product comprising a computer readable storage medium having program instructions embodied therewith, wherein the computer readable storage medium is not a transitory medium per se, the program instructions being executable by a device to cause the device to perform a method comprising:
detecting a reference to a date or a date and time in a communication associated with a user;
determining a context in which the date or date and time is used in the communication in response to detecting the reference to the date or the date and time in the communication;
determining a participation of the user in a prospective event associated with the date or the date and time based on the context of the communication;
comparing the date or the date and time associated with the prospective event to a date or a date and time of each of a plurality of scheduled events previously scheduled in a calendar system of the user to detect any conflict in response to the participation of the user in the prospective event;
detecting a conflict between the date or the date and time associated with the prospective event and the date or the date and time of a previously scheduled event of the plurality of previously scheduled events in response to the date or the date and time associated with the prospective event at least partially corresponding to the date or the date and time of the previously scheduled event; and
automatically presenting an indication of the conflict to the user in response to detecting the conflict.

20. The computer program product of claim 19, wherein the method further comprises providing a feature for the user to view an available date or an available date and time for scheduling the prospective event.
